(19) United States
(12) Patent Application Publication
(10) Pub. No.: US 2007/0037053 A1
(43) Pub. Date: Feb. 15, 2007

(54) Battery case having improved thermal conductivity

(76) Inventor: Satish Anantharaman, Rochester, MI (US)

Correspondence Address: Anthony J. Serventi;Cobasys LLC, 3740 Lapeer Road South, Orion, MI, 48359, US

(21) Appl. No.: 11/202,719

(22) Filed: Aug. 12, 2005

(51) Int. Cl. H01M 2/02

(52) U.S. Cl. 429/176

(57) ABSTRACT

The present invention discloses is a battery case, comprising a base case and an insert as two parts of the exterior case. The base case is formed of a first polymeric material and the insert is formed of a second polymeric material, wherein the second polymeric material has a higher thermal conductivity than the first polymeric material. The second polymeric material may comprise a base polymer and at least one thermally conductive filler, such as ceramic, glass or carbon fiber. The base polymer of the second polymeric material may be selected from the group consisting of polyphenylene ether, polystyrene, polypropylene, polyphenylene sulfide and the ceramic filler may be selected from the group consisting of alumina, fused silica, a glass ceramic sold under the trademark MACOR®, boron nitride, silicon nitride, boron carbide, aluminum nitride, silicon carbide, zirconia and combinations thereof. The first polymeric material may be selected from the group consisting of polyphenylene ether, polystyrene, polypropylene, polyphenylene sulfide. The base case and insert may be integrally molded by one of two-color molding and insert molding with the first polymeric material and the second polymeric material. The battery case of the present invention may comprise a monoblock alkaline storage battery case.

### FIELD OF THE INVENTION

The present invention relates to a battery case having improved thermal conductivity and an alkaline storage battery. More particularly, the present invention relates to a battery case and an alkaline storage battery that includes a thermally conductive polymeric material, wherein the polymeric material allows for the transfer of heat away from the battery and battery case.

### BACKGROUND OF THE INVENTION

Rechargeable batteries are used in a variety of industrial and commercial applications such as fork lifts, golf carts, uninterruptible power supplies, and electric vehicles.

Rechargeable lead-acid batteries are a useful power source for starter motors for internal combustion engines. However, their low energy density (about 30 wh/kg) and their inability to reject heat adequately, makes them an impractical power source for electric vehicles (EV), hybrid electric vehicles (HEV) and 2-3 wheel scooters/motorcycles. Electric vehicles using lead-acid batteries have a short range before requiring recharge, require about 6 to 12 hours to recharge and contain toxic materials. In addition, electric vehicles using lead-acid batteries have sluggish acceleration, poor tolerance to deep discharge, and a battery lifetime of only about 20,000 miles.

Nickel-metal hydride batteries (“Ni-MH batteries”) are far superior to lead-acid batteries, and Ni-MH batteries are the ideal battery available for electric vehicles, hybrid vehicles and other forms of vehicular propulsion. For example, Ni-MH batteries, such as those described in U.S. Pat. No. 5,277,999, the disclosure of which is hereby incorporated herein by reference, have a much higher energy density than lead-acid batteries, can power an electric vehicle over 250 miles before requiring recharge, can be recharged in 15 minutes, and contain no toxic materials.

Extensive research has been conducted in the past into improving the electrochemical aspects of the power and charge capacity of Ni-MH batteries, which is discussed in detail in U.S. Pat. Nos. 5,096,667, 5,104,617, 5,238,756 and 5,277,999, the contents of which are all hereby incorporated herein by reference.

The mechanical and thermal aspects of the performance of Ni-MH batteries have important aspects of operation. For example, in electric vehicles and in hybrid vehicles, the weight of the batteries is a significant factor. For this reason, reducing the weight of individual batteries is a significant consideration in designing batteries for electric and hybrid vehicles. Battery weight should be reduced while still affording the necessary mechanical requirements of the battery (i.e. ease of transport, ruggedness, structural integrity, etc.).

Electric vehicle and hybrid vehicle applications introduce a critical requirement for thermal management. Individual electrochemical cells are placed together in close proximity and many cells are electrically coupled together. Therefore, since there is an inherent tendency to generate significant heat during charge and discharge, a workable battery design for electric and hybrid vehicles is judged by whether or not the generated heat is sufficiently controlled. Sources of heat are primarily threefold. First, ambient heat due to the operation of the vehicle in hot climates; second, resistive or I²R heating on charge and discharge, where I represents the current flowing into or out of the battery and R is the resistance of the battery; and third, a tremendous amount of heat is generated during overcharge due to gas recombination.

Batteries have been developed which reduce the overall weight thereof and incorporate the necessary thermal management needed for successful operation in electric and hybrid vehicles and other applications, without reducing its energy storage capacity or power output. One such battery design is a monoblock battery. An example of a monoblock battery is provided in U.S. Pat. No. 6,255,051 issued to Corrigan et al. on Jul. 3, 2001, the contents of which are hereby incorporated herein by reference. Another example of a monoblock battery is provided in U.S. Pat. No. 6,689,510 issued to Gow et al. on Feb. 10, 2004, the contents of which are hereby incorporated herein by reference. Another example of a monoblock battery is provided in U.S. patent application Ser. No. 09/861914, the disclosure of which is hereby incorporated herein by reference.

Polymers are widely used as materials of choice in prismatic battery enclosures due to numerous advantages. Those advantages include lower cost, lower weight and easier manufacturability with respect to metal cases. In order to ensure that such a battery fulfills life expectations it is important to transfer heat away from the battery. Although polymers typically have excellent volume resistivity and dielectric properties, poor thermal conductivity is a drawback.

Currently, there exists a need in the art for battery case having a design that may be easily modified for a plurality of applications and provide effective thermal management and mechanical stability. The present invention overcomes deficiencies in the prior art by incorporating a flexible base design with polymer materials having differing thermal resistivity to develop a battery having improved thermal management and improved structural integrity.

### SUMMARY OF THE INVENTION

Disclosed herein is a battery case, comprising a base case and an insert as two parts of the exterior case. The base case is formed of a first polymeric material and the insert is formed of a second polymeric material, wherein the second polymeric material has a higher thermal conductivity than the first polymeric material. The second polymeric material may comprise a base polymer and at least one thermally conductive filler, such as ceramic, glass or carbon fiber. The base polymer of the second polymeric material may be selected from the group consisting of polyphenylene ether, polystyrene, polypropylene, polyphenylene sulfide and the ceramic filler may be selected from the group consisting of alumina, fused silica, a glass ceramic sold under the trademark MACOR®, boron nitride, silicon nitride, boron carbide, aluminum nitride, silicon carbide, zirconia and combinations thereof. The first polymeric material may be selected from the group consisting of polyphenylene ether, polystyrene, polypropylene, polyphenylene sulfide. The base case and insert may be integrally molded by one of two-color molding and insert molding with the first polymeric material and the second polymeric material.

Preferred embodiments incorporate fins on the exterior of the battery case. The use of fins provides mechanical stability and more efficient cooling. Fins provide additional surface area on the case that aids in the transfer of heat from the interior of the battery.

The case may be designed for a base shape that may be incorporated in a variety of applications. The base shape is designed with an opening that may accept inserts. The inserts may be constructed of materials having varying degrees thermal conductivity. The insert may be constructed of a material that is at least as thermally conductive as the base shape, preferably the insert is more thermally conductive than the base shape. As batteries increase in size the amount of heat generated also increases. Additionally, the heat may be further dissipated using liquid or gas/air cooling to aid in thermal management. These cooling strategies may be used in conjunction with the case of the present invention.

### BRIEF DESCRIPTION OF THE DRAWINGS

In order to assist in the understanding of the various aspects of the present invention and various embodiments thereof, reference is now made to the appended drawings, in which like reference numerals refer to like elements. The drawings are exemplary only, and should not be construed as limiting the invention.

FIG. 1A is a side view illustration of an embodiment of the present invention battery case, wherein a first polymeric material and a second polymer material form the battery case, the second polymeric material forming the side walls of the battery case;

FIG. 1B is a cross sectional illustration of FIG. 1A along line B-B, wherein the preferred assembly is illustrated;

FIG. 1C is a top view illustration of a FIG. 1A, wherein the vent assembly is illustrated;

FIG. 1D is a magnified view of FIG. 1B along line D, wherein the intracell connections and welds are illustrated;

FIG. 1E is a side view illustration of an embodiment of the present invention is a battery case wherein thermally conductive fins and cell interlocks are illustrated;

FIG. 2A is a side view illustration of an embodiment of the present invention battery case, wherein the first case part is designed with an opening for receiving the second case part;

FIG. 2B is a magnified view of FIG. 2A along line B, wherein the air flow across a side wall is illustrated;

FIG. 2C is an illustration of an embodiment of the present invention battery case, wherein the air flow across the front cover is illustrated;

FIG. 3A is an illustration of an embodiment of the present invention, wherein the air flow across the front covers of a series of interlocked battery cases is illustrated;

FIG. 3B is an illustration of an embodiment of the present invention, wherein the lateral air flow between the side walls of a series of interlocked battery cases is illustrated;

FIG. 3C is an illustration of an embodiment of the present invention, wherein the longitudinal air flow between the side walls and across the covers of a series of interlocked battery cases is illustrated;

FIG. 4A is front cover view illustration of an embodiment of the present invention two cell monoblock module, wherein a first polymeric material and a second polymer material form the battery case of the module, the second polymeric material comprising inserts into the front cover of the battery case;

FIG. 4B is a side view illustration of a FIG. 4A, wherein the vent assembly and module terminal of the module are illustrated;

FIG. 4C is a cross sectional illustration of FIG. 4B along line C-C, wherein the preferred assembly of the module is illustrated;

FIG. 4D is a top view illustration of a FIG. 4A, wherein the top cover of the module is illustrated;

FIG. 4E is a bottom view illustration of FIG. 4A, wherein the bottom cover and feet of the module are illustrated;

FIG. 4F is a front view illustration of an embodiment of the present invention, wherein the base case is illustrated;

FIG. 4G is a front view illustration of an embodiment of the present invention, wherein an insert having corresponding grooves is illustrated;

FIG. 5A is front cover view illustration of an embodiment of the present invention two cell monoblock module, wherein longitudinal air flow across the inserts and through the fins is illustrated;

FIG. 5B is a side view of FIG. 5A along line B, wherein the air flow across a side wall is illustrated;

FIG. 6A is an illustration of an embodiment of the present invention, wherein the air flow across and between the covers of a series of interlocked two cell modules is illustrated;

FIG. 6B is an illustration of an embodiment of the present invention, wherein the longitudinal air flow across and between the side walls of a series of interlocked battery cases is illustrated;

FIG. 6C is a to view of a series of interlocked two cell modules; and

FIG. 6D is a perspective view of series of interlocked two cell modules.

### DETAILED DESCRIPTION OF EMBODIMENTS OF THE INVENTION

The present invention discloses a battery and battery case having improved thermal conductivity. The battery case may be formed from a first polymeric material and a second polymeric material, wherein the second polymeric material has a higher thermal conductivity than the first polymeric material. The differing thermal conductivity promotes the transfer of heat away from the battery cell(s). Additionally, by strategic placement of the thermally conductive material, the overall weight of the system is not dramatically increased and heat transfer is maximized.

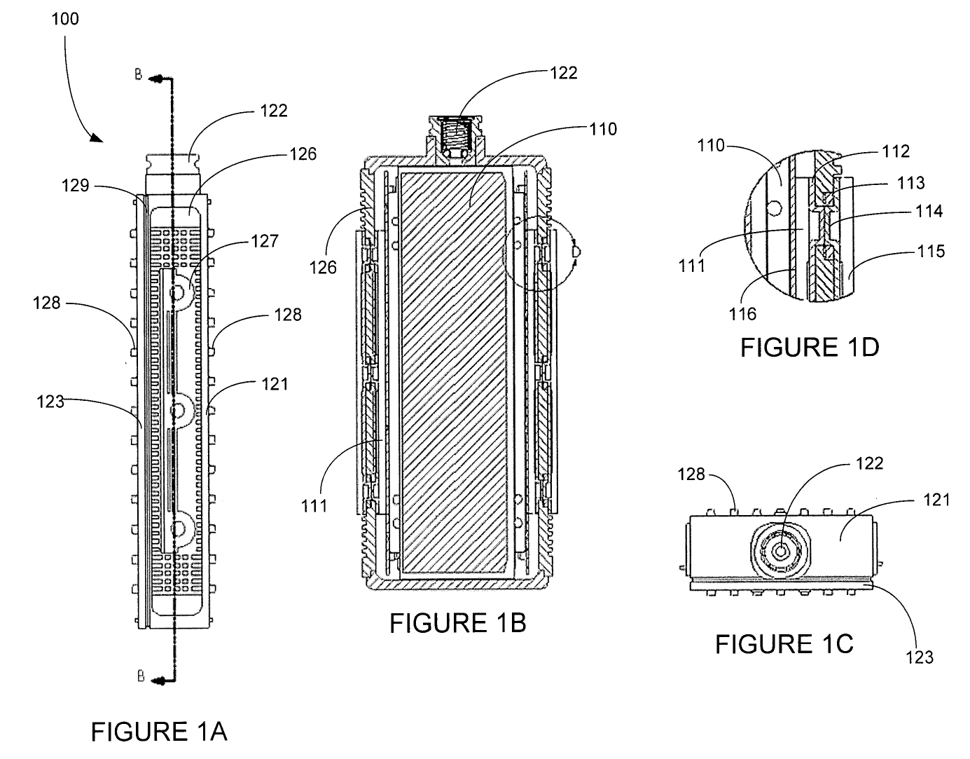

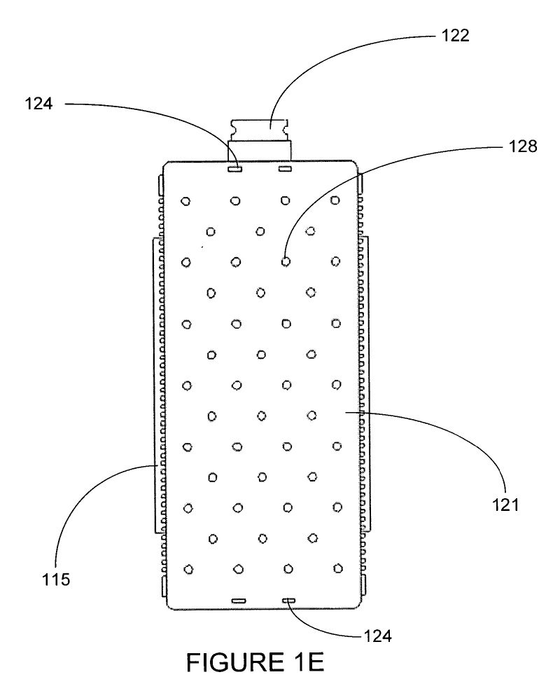

Referring to FIGS. 1A-1E, an embodiment of a battery, generally referred to as 100, of the present invention is illustrated. A first polymeric material comprises a battery enclosure on the top 121A and bottom 121B and a battery cover on the front 123A and back 123B. A second polymeric material comprises thermally conductive side walls 126A and 126B. In this embodiment, the thermally conductive side walls 126A and 126B assists in the transfer heat generated by the electrode stack 110 and the heat is transferred away from the battery 100. The weld flash trap 129 ensures that the plastic melt squeezed out due to the welding process is trapped. This eliminates un-necessary secondary operations to remove weld flash, i.e. melt. Preferably, a baffle assists in the regulation of air flow. The design of the baffle may be optimized to provide sufficient airflow to the module and for the creation of convection cycles. This would improve the ability of the module to transfer the heat generated.

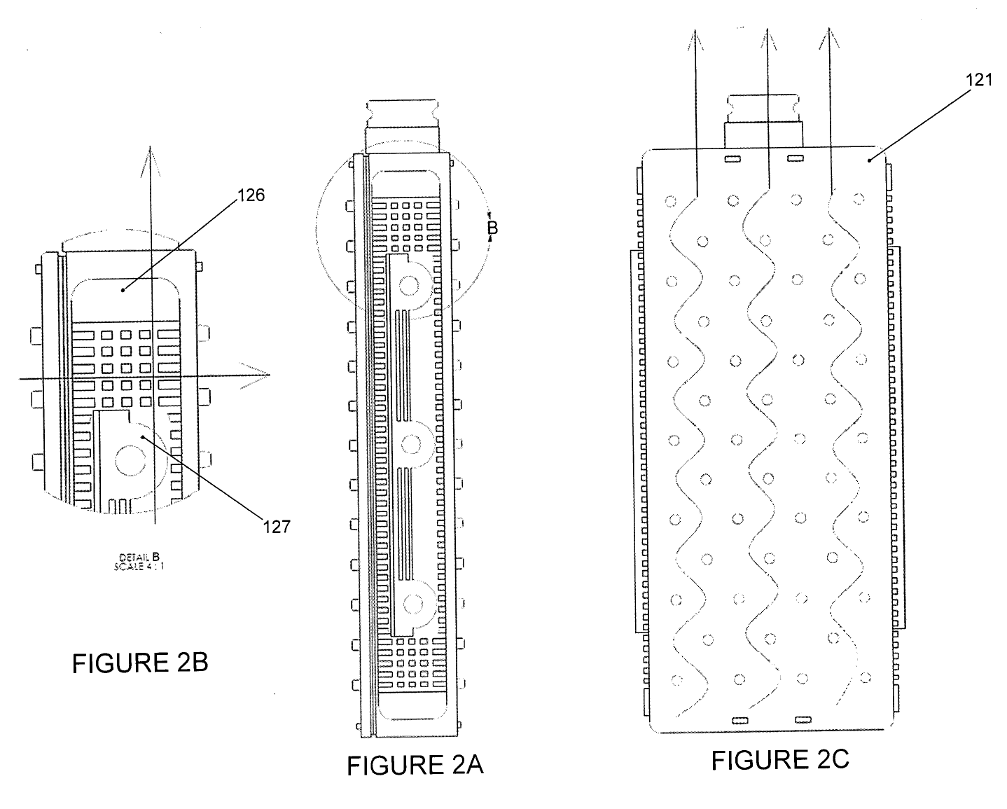

As the electrode stack 110 charges and discharges, the heat generated is transferred away by the thermally conductive side walls 126A and 126B. Preferably, heat exchange fins 128 are incorporated into the system on the front battery cover 123A and back battery cover 123B. The fins 128 preferably comprise a thermally conductive material, wherein the thermally conductive material may be the same as or different from the material used for the thermally conductive side walls 126A and 126B. The heat exchange fins 128 draw heat away from the battery cover as heat is generated. Further, the heat is preferably dissipated by air flowing over the battery covers 123A and 123B and through the fins 128, as illustrated in FIG. 2C. As heat is produced, the heat will rise away from the battery case and drawing cooler air into contact with the battery covers 123A and 123B and the fins 128. The fins 128 provide additional surface area on the case that aids in the transfer of heat from the interior of the battery. In addition to the dissipation of heat, the fins 128 provide mechanical stability to the battery 100.

Referring to FIG. 1D, an intracell connection is illustrated. Preferably, a battery of the present invention has at least one intracell connection as described hereinafter. More preferably, a battery of the present invention has three intracell connection per side 126A and 126B. The electrode stack 110 is in electrical communication with a first electrode tab 116. The first electrode tab 116 is in electrical communication with the second electrode tab 111 and the electrode tab 111 is set proximate to and in contact with an internal current collector 112. The internal current collector 12 is set proximate to and in contact with an external current collector 127. Preferably, the internal current collector 112 is welded to the external current collector 127. The structural integrity is maintained by the thermally conductive side walls 126A and 126B, which also transfer the heat generated by the system.

The second polymeric material may comprise a base polymer and at least one thermally conductive filler, such as ceramic or glass. The base polymer of the second polymeric material may be selected from the group consisting of polyphenylene ether, polystyrene, polypropylene, polyphenylene sulfide or any combination thereof.

Examples of ceramics that may be used as thermally conductive filler includes but are not limited to the group consisting of alumina, fused silica, a glass ceramic sold under the trademark MACOR®, boron nitride, silicon nitride, boron carbide, aluminum nitride, silicon carbide, zirconia and any combination thereof. Boron nitride is the preferred thermally conductive filler. The first polymeric material may be selected from the group consisting of polyphenylene ether, polystyrene, polypropylene, polyphenylene sulfide or any combination thereof. The base case and insert may be integrally molded by one of two-color molding and insert molding with the first polymeric material and the second polymeric material.

Preferably, the thermal conductivity of the second polymeric material is higher than the first polymeric material. Preferably, the thermal conductivity of the second polymeric material is about 1.0 W/mk to about 10 W/mk and the thermal conductivity of the first polymeric material is about 0.2 W/mk to about 1.0 W/mk. Preferably, the volume resistivity of the second polymeric material is about 0.1 ohm. cm to about 1E15 ohm. cm and the volume resistivity of the first polymeric material is about 1E12 ohm. cm to about 1E15 ohm. cm.

The size and shape of the ceramic filler depends upon the given needs of the desired cell or module. Typically, as the amount of energy produced by the battery increases, the amount of heat will also increase. As a result, the thermal conductivity of the second polymeric material will preferably increase to allow for the efficient transfer of heat away from the battery. Further, other factors, such as cost, will determine the percentage of filler in the second polymeric material.

The ceramic filler particles may be platelets or spherical depending on the nature of heat transfer required. For example, platelets are typically used in heat spreading applications and provide anisotropic heat transfer, while spherical particles provide a more isotropic heat transfer. The thermal conductivity of the filler particles may vary from 50 W/mK to over 300 W/mK. The ceramic filler particles may vary from sub micron diameters to over 500 microns depending on the thickness of the plastic component.

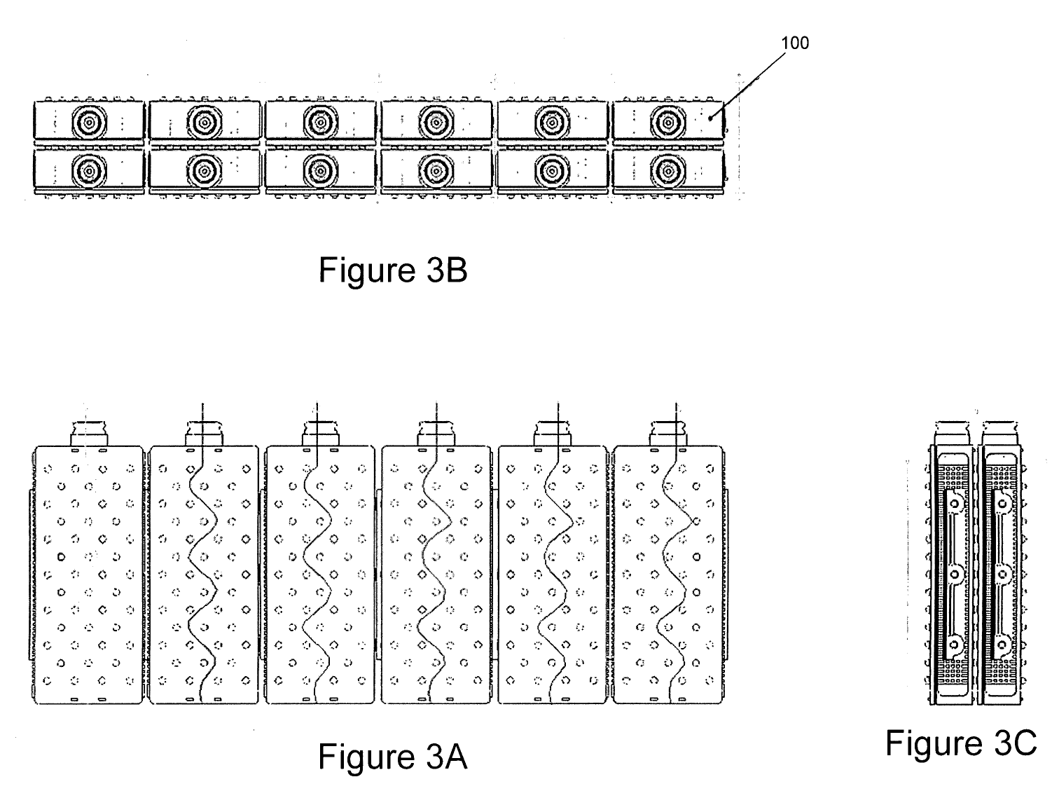

Referring to FIG. 3A, an embodiment of the present invention is illustrated, wherein a plurality of cells 301 are interlocked and electrically connected to produce a module, generally referred to as 300.

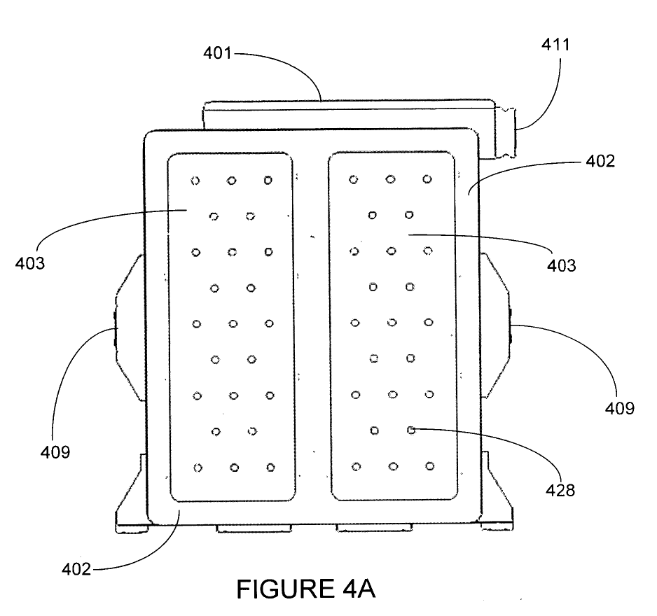

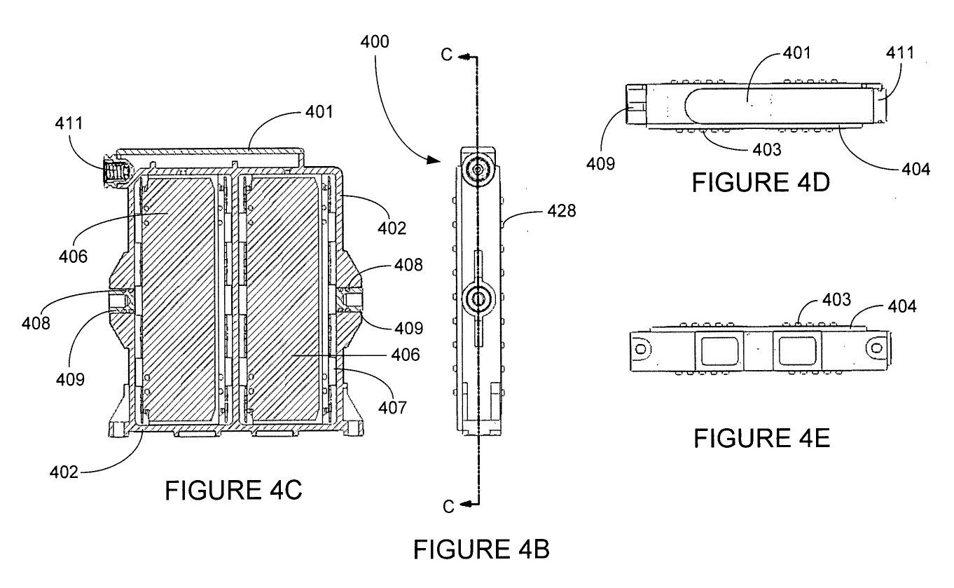

The thermally conductive battery case of the present invention may accommodate a plurality of electrochemical cells to form a monoblock battery, generally referred to as 400, as illustrated in FIGS. 4A-4E. Preferably, a single electrochemical cell is placed in each separate cell compartment. In one embodiment, a single electrochemical cell is disposed in each of the cells compartments.

The battery case of the monoblock battery 400 may have interchangeable parts designed to allow a base case to be used for multiple applications. The base case is illustrated in FIG. 4F. Grooves may be incorporated into the base case 450, wherein the grooves correspond to complementary grooves in an insert 451, illustrated in FIG. 4G. The inserts 451 may be designed with varying weight and hydrogen impermeability, depending upon the needs of a given system. Preferably, the insert 451 has a higher thermal conductivity than the base case.

The base case 450 may be designed with a flange around the periphery of the opening. The insert 451 may be designed to set against the flange. Further, the contact points between the base case and the insert may be secured by welding or other method, such as adhesive. The welding may be any welding process, such as laser welding, vibration welding or ultrasonic welding. The battery case is preferably sealed to prevent the uncontrolled escape of hydrogen or other gases from the battery. As described below, a vent assembly controls and monitors the escape of hydrogen and other gases from the battery. Also, by sealing the battery case, elements, such as moisture, may be inhibited and preferably prevented from entering the interior of the battery case.

As mentioned above, an embodiment of the present invention may be incorporated into a monoblock battery having any number of cells. Referring to FIGS. 4A-4E, a monoblock battery 400 having two cells is illustrated. The cells may be connected in series or parallel. However, it should be understood that the embodiment illustrated in FIGS. 4A-4E discloses a two cell monoblock module 400; however, additional cell may be incorporated depending upon the needs of a given system. The basic interconnections between the common walls of the cells will remain consistent. A first polymeric material comprises a module top cover 401 and module enclosure 402. The module enclosure 402 forms the framework for the monoblock module 400 and is designed to receive one or more inserts 403. A second polymeric material comprises inserts 403. Preferably the inserts 403 have a higher thermal conductivity than the module enclosure 402. The thermally conductive inserts 403 assist in the transfer heat generated by the electrode stack 406 and the heat is transferred away from the battery 400.

Preferably, the module top cover 401 has an integrated vent assembly 411. The vent assembly 411 monitors and controls the release of hydrogen and other gases produced internally of the module 400. The vent assembly 411 is adapted to release internal pressure that may damage the electrode stack 406 and module seals.

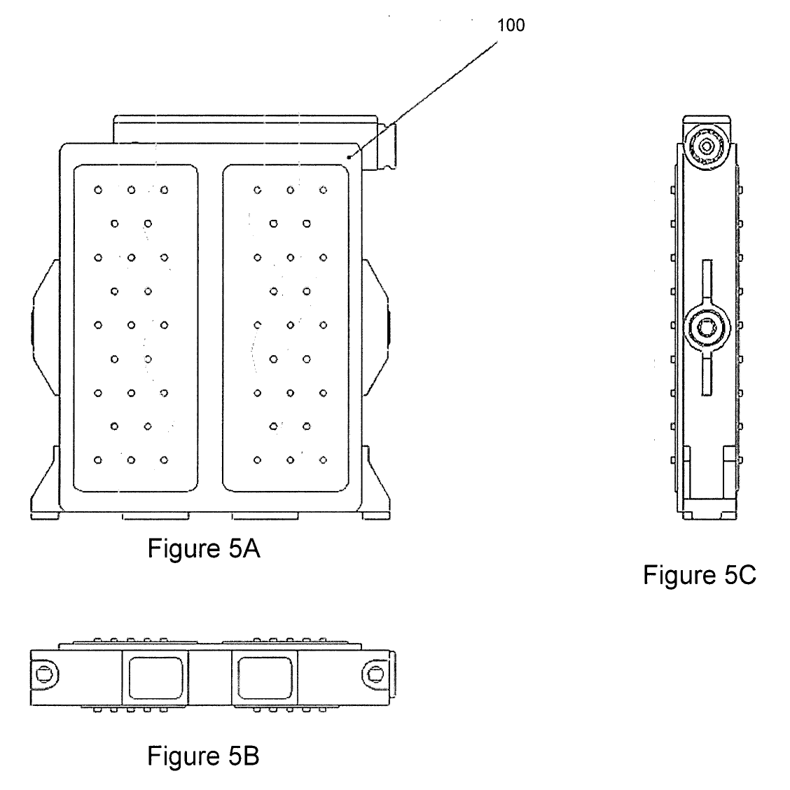

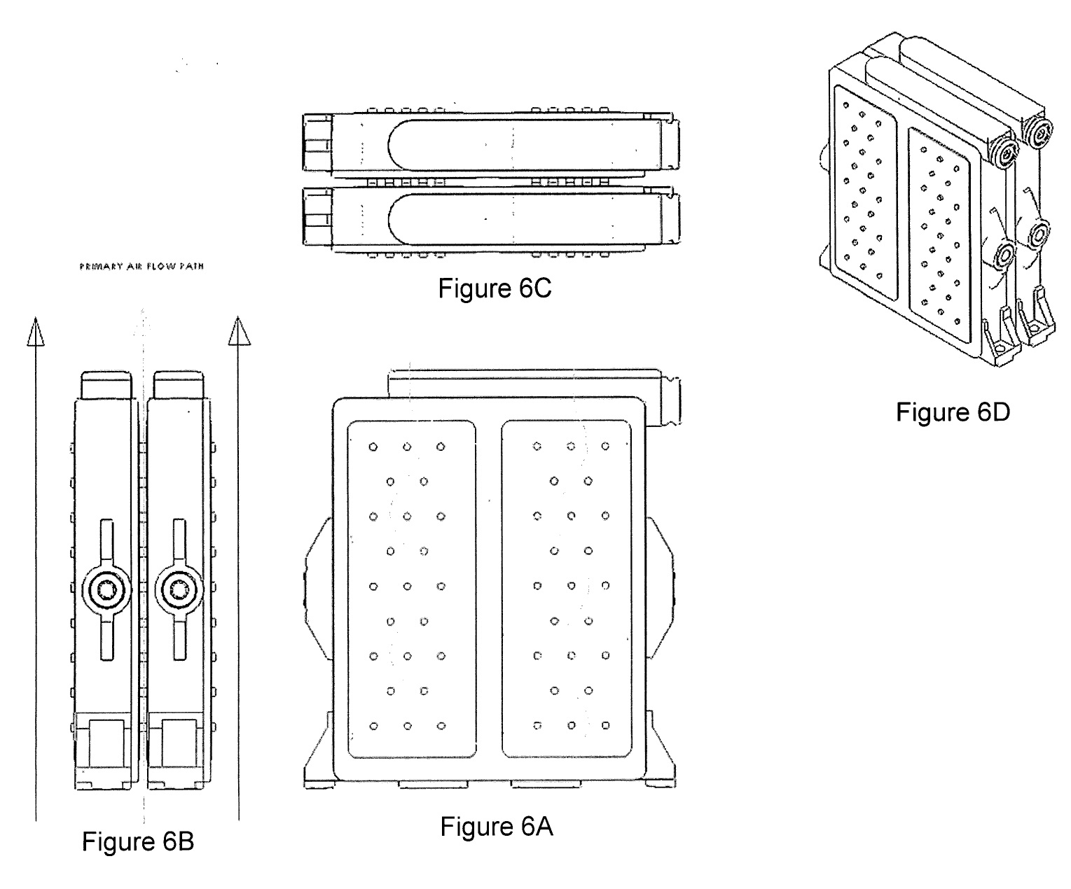

As the electrode stack 406 charges and discharges, the heat generated is transferred away by the module enclosure 402. Preferably, heat exchange fins 428 are incorporated into the system on the inserts 403. The fins 428 preferably comprise a thermally conductive material, wherein the thermally conductive material may be the same as or different from the material used for the module enclosure 402. The heat exchange fins 428 draw heat away from the battery 400 as heat is generated. Further, the heat is preferably dissipated by air flowing over the inserts 403 and through the fins 428, as illustrated in FIGS. 5A and 5B. As heat is produced, the heat will rise away from the battery case and drawing cooler air into contact with the inserts 403 and the fins 428. The module 400 may be designed with a side cover 404, wherein the side cover is designed to receive and secure the inserts 403.

Referring to FIG. 4C, a battery of the present invention preferably has at least one intracell connection per cell as described hereinafter. More preferably, each cell of the module 400 has three intracell connection per side. The electrode stack 406 is in electrical communication with the electrode tab 412 and the electrode tab 412 is set proximate to and in contact with an internal current collector 407. The internal current collector 407 is set proximate to and in contact with an external current collector 414. Preferably, the internal current collector 407 is welded to the external current collector 414.

Preferably, the module 400 includes at least one terminal 409 integrated into the module enclosure 402. The module terminal 409 provides a mechanism that enables a user to access the electrical current produced by the cells contained within the module 400. The terminal may incorporate any known terminal design, although the design illustrated is described.

It may also be possible that more than one electrochemical cell be placed in at least one of the cell compartments. For example, two or more electrochemical cells may be placed into a single cell compartment by first placing each of these electrochemical cells into a protective polymeric bag prior and placing the cells into the cell compartment. The polymeric bag prevents the electrolyte of each of the electrochemical cells (within the compartment) from contacting the electrolyte of any of the other electrochemical cells within the compartment.

The following relates generally to all of the embodiments discussed above. Each electrochemical cell preferably includes a stack of one or more positive electrodes, one or more negative electrodes, separators separating the positive electrodes from the negative electrodes, and an electrolyte. The stacks of electrodes are preferably positioned within each of the cell compartments so that the wide faces of the electrode plates are parallel to the longitudinal walls of each of the containers. However, it is also conceivable that the stacks of electrodes be positioned within the cell compartments in other ways. For example, the wide faces of the plates may be set parallel to the lateral walls.

Some or all of the electrochemical cells disposed within the battery case may be electrically coupled together in a serial electrical connection and/or a parallel electrical connection. In one embodiment, all of the electrochemical cells are electrically coupled in series. In another embodiment, all of the electrochemical cells are electrically coupled in parallel. In yet another embodiment, a portion of the electrochemical cells is electrically coupled in series while a portion is electrically coupled in parallel. It is also possible to have multiple groups of cells where the cells within each group are electrically interconnected to each other while the cells of one group are not electrically connected to the cells of any other group.

The positive and negative electrodes may include current collection tabs attached to the electrodes for transporting electrical energy into and out of the electrode plates. The current collection tabs of the positive electrodes of each electrochemical cell are all welded together into a positive interconnect. Likewise, the current collection tabs of the negative electrodes of each cell are all welded together into a negative interconnect. To connect all of the electrochemical cells in series, the positive interconnect of one electrochemical cell is electrical coupled to the negative interconnect of an adjacent electrochemical cell. This may be done in any number of ways known in the art. For example, the electrochemical cells may be connected in series by connection spacers coupled between the positive interconnect of another electrochemical cell in an adjacent cell compartment. Connection spacers may also connect the electrochemical cells to the negative battery terminal and to the positive battery terminal. The connection spacers may be formed from many different conductive materials. For example, they may be formed from nickel, copper, a nickel alloy, a copper alloy, nickel-plated copper, or nickel-plated copper alloy. The connection spacers are preferably welded to the positive and negative interconnects as well as to the positive and negative battery terminals.

The connection spacers are preferably positioned so that they go over the top of the container partitions and walls. This may be accomplished by placing the connection spacers in a specially designed lid for the battery case. It is also conceivable that the connection spacers could be positioned so that they go through small openings placed in the partitions and walls of the containers.

The embodiments of the present invention are preferably designed so that the electrolyte within each of the cell compartments is isolated from the electrolyte of any other of the cell compartments. This is done to avoid self-discharge electrical shorting paths between the cells. However, it is preferable that the gases from each of the individual cells are all shared within a common region of the battery case so that the battery case serves as a common pressure vessel for each of the electrochemical cells within the battery. Further, one or more vent assemblies are preferably integrated into the battery case to monitor and control the release of gas. The common region of the battery case may be incorporated into a specially designed top for the battery case, as illustrated in FIG. 4C. In this embodiment, a vent assembly 411 is integrated in the top 401.

To help prevent electrolyte leakage between cell compartments each of the openings in the top of the cell compartments may be covered with a gas-permeable, hydrophobic membrane. The membrane coverings will prevent the escape of the electrolyte from each compartment. However, since they are gas-permeable, they will permit the gases from each of the cell compartments to enter the common region within the battery case.

The gas-permeable, hydrophobic membrane may be formed of a material that has a gas diffusion surface area sufficient to compensate for the overcharge gas evolution rate. The may be from about 5 cm² to about 50 cm² per 12 Ah cell. Generally, the hydrophobic material is any material which allows passage of the battery gases but not the battery electrolyte. Examples of materials are materials comprising polyethylene with calcium carbonate filler. Other examples include many types of diaper material. An example of a material which may be used is the breathable type XBF-100W EXXAIRE film that is supplied by Tridegar products. This film is a polyethylene film that has been mixed with fine calcium carbonate particles and then further stretched to make it porous. In one embodiment, the layer is chosen to have a thickness of about 0.25 gauge (0.25 g per square meters), which corresponds to about 0.001 inch. The Gurley porosity of the material is chosen to be about 360 (360 seconds for 100 cc of gas to pass per square inch with a gas pressure of 4.9 inches of water). The hydrophobic nature of this film is demonstrated by a very high contact angle in 30% KOH electrolyte of about 120° C.

Generally, the electrolyte used in the battery case of the present invention may be any aqueous or nonaqueous electrolyte. An example of a nonaqueous electrochemical cell is a lithium-ion cell which uses intercalation compounds for both anode and cathode and a liquid organic or polymer electrolyte. Aqueous electrochemical cells may be classified as either “acidic” or “alkaline”. An example of an acidic electrochemical cell is a lead-acid cell which uses lead dioxide as the active material of the positive electrode and metallic lead, in a high-surface area porous structure, as the negative active material. Preferably, the electrochemical cell of the present invention is an alkaline electrochemical cell. The alkaline electrolyte may be an aqueous solution of an alkali metal hydroxide. Preferably, the alkaline electrolyte includes an aqueous solution of potassium hydroxide, sodium hydroxide, lithium hydroxide or mixtures thereof. The alkaline electrolyte may be a mixed alkali hydroxide of potassium and lithium hydroxide.

Preferably, the electrolyte will not degrade the first polymeric material or the second polymeric material. Also, the filler for the second polymeric material preferably will not degrade in the chosen electrolyte. For example, aqueous potassium hydroxide and aqueous lithium hydroxide will degrade aluminum. As a result, aluminum nitride is a less preferred filler for the second polymeric material, when the electrolyte, such as potassium hydroxide or lithium hydroxide, may degrade an aluminum containing filler.

Generally, the positive and negative active materials used in the battery of the present invention may be any type of active battery materials used in the art. Examples of positive electrode materials are powders of lead oxide, lithium cobalt dioxide, lithium nickel dioxide, lithium nickel dioxide, lithium manganese oxide compounds, lithium vanadium oxide compounds, lithium iron oxide, lithium compounds, i.e., complex oxides of these compounds and transition metal oxides, manganese dioxide, zinc oxide, nickel oxide, nickel hydroxide, manganese hydroxide, copper oxide, molybdenum oxide, carbon fluoride, etc. Preferably, the positive electrode active material is a nickel hydroxide material.

Examples of negative electrode materials include metallic lithium and like alkali metals, alloys thereof, alkali metal absorbing carbon materials, zinc, cadmium hydroxide, hydrogen absorbing alloys, etc. Preferably, the negative electrode active material is a hydrogen absorbing alloy (also referred to in the art as a hydrogen storage alloy). It is within the spirit and intent of this invention that any hydrogen absorbing alloy can be used. In a preferable embodiment of the present invention, each electrochemical cell is a nickel-metal hydride cell comprising negative electrodes including hydrogen absorbing alloy materials as the active material, and positive electrodes including nickel hydroxide as the active material.

In a preferred embodiment of the present invention, the battery is a nickel-metal hydride monoblock battery. Hence, the monoblock battery case embodiment of the present invention preferably withstands pressures of at least the standard operating pressures of a sealed nickel-metal hydride battery. This may vary depending upon the actual hydrogen absorbing alloy and nickel hydroxide materials used as the active electrode materials. In one embodiment of the invention, the monoblock battery may operate at a peak pressure of at least 10 psi, preferably at a peak pressure of at least 25 psi and more preferably at a peak pressure of at least 50 psi. In another embodiment of the invention, the monoblock battery may operate at peak pressures up to about 140 psi. Hence, it is preferable that an embodiment of the monoblock case should be able to withstand peak operating pressures from about 10 psi to about 140 psi. However, the monoblock battery and battery case of the present invention are not limited to such operating pressures.

While the invention has been illustrated in detail in the drawings and the foregoing description, the same is to be considered as illustrative and not restrictive in character as the present invention and the concepts herein may be applied to any formable material. It will be apparent to those skilled in the art that variations and modifications of the present invention can be made without departing from the scope or spirit of the invention. Thus, it is intended that the present invention cover all such modifications and variations of the invention that come within the scope of the appended claims and their equivalents.

We claim:

1. A battery case, comprising
a first polymeric material; and
a second polymeric material, said second polymeric material having a higher thermal conductivity than said first polymeric material, said second polymeric material promoting the transfer of heat from the battery case.

2. The battery case of claim 1, said second polymeric material comprising a base polymer and at least one thermally conductive filler.

3. The battery case of claim 2, said thermally conductive filler comprising a ceramic filler.

4. The battery case of claim 3, said ceramic filler selected from the group consisting of alumina, fused silica, boron nitride, silicon nitride, boron carbide, aluminum nitride, silicon carbide, zirconia and any combination thereof.

5. The battery case of claim 4, said first polymeric material selected from the group consisting of polyphenylene ether, polystyrene, polypropylene, polyphenylene sulfide and any combination thereof.

6. The battery case of claim 1, said second polymeric material having a thermal conductivity of about 1.0 W/mk to about 10 W/mk and said first polymeric material having a thermal conductivity of about 0.2 W/mk to about 1.0 W/mk.

7. The battery case of claim 1, said case comprising at least one insert and a base, said second polymeric material comprising said insert and said first polymeric material comprising said base.

8. A alkaline storage battery, comprising
a base case comprising a first polymeric material;
an insert comprising a second polymeric material, said second polymeric material having a higher thermal conductivity than said first polymeric material, said insert promoting the transfer of heat from the battery case; and
at least one electrode stack.

9. The alkaline storage battery of claim 8, said base case adapted to receive said insert.

10. The alkaline storage battery of claim 8, said second polymeric material comprising a base polymer and at least one ceramic filler.

11. The alkaline storage battery of claim 10, said ceramic filler selected from the group consisting of alumina, fused silica, boron nitride, glass ceramic, silicon nitride, boron carbide, aluminum nitride, silicon carbide, zirconia and compounds thereof.

12. The alkaline storage battery of claim 11, said first polymeric material selected from the group consisting of polyphenylene ether, polystyrene, polypropylene, polyphenylene sulfide and any combination thereof.

13. The alkaline storage battery of claim 8, the base case and the insert integrally molded by one of two-color molding and insert molding with the first polymeric material and the second polymeric material.

14. The alkaline storage battery of claim 9, said base case further comprising an outer flange and said insert further comprising an inner flange, said outer flange contacting said inner flange.

15. The alkaline storage battery of claim 8, said second polymeric material having a volume resistivity of about 0.1 ohm. cm to about 1E15 ohm. cm and said first polymeric material having a volume resistivity of about 1E12 ohm. cm to about 1E15 ohm. cm.

16. The alkaline storage battery of claim 8, further comprising thermally conductive fins.

17. A monoblock alkaline storage battery, comprising:
a base case comprising a first polymeric material;
an insert comprising a second polymeric material, said second polymeric material having a higher thermal conductivity than said first polymeric material, said insert promoting the transfer of heat from the battery case; and
a plurality of electrode stacks.

18. The alkaline storage battery of claim 17, said second polymeric material comprising a base polymer and at least one ceramic filler.

19. The alkaline storage battery of claim 18, said ceramic filler selected from the group consisting of alumina, fused silica, boron nitride, glass ceramic, silicon nitride, boron carbide, aluminum nitride, silicon carbide, zirconia and compounds thereof.

20. The alkaline storage battery of claim 19, said first polymeric material selected from the group consisting of polyphenylene ether, polystyrene, polypropylene, polyphenylene sulfide and any combination thereof.
